(19) United States
(12) Patent Application Publication
(10) Pub. No.: US 2025/0028508 A1
(43) Pub. Date: Jan. 23, 2025

(54) DEVELOPING MIXED REALITY APPLICATIONS IN CONNECTION WITH A VIRTUAL DEVELOPMENT ENVIRONMENT

(71) Applicant: simpleAR, Inc., Irvine, CA (US)

(72) Inventors: Julian Volyn, Long Valley, NJ (US); Michael Davis, Yorba Linda, CA (US); TJ Southard, Newport, NC (US); Phillip Do, Chandler, AZ (US); Josh Zavaleta, Aliso Viejo, CA (US); James Williams, Anaheim, CA (US); Marlo Brooke, Newport Coast, CA (US); Scott Toppel, Virginia Beach, VA (US)

(21) Appl. No.: 18/583,357

(22) Filed: Feb. 21, 2024

Related U.S. Application Data
(60) Provisional application No. 63/515,081, filed on Jul. 21, 2023.

(51) Int. Cl. G06F 8/34; G06F 3/04815; G06T 13/20; G06T 19/00

(52) U.S. Cl. CPC G06F 8/34; G06T 13/20; G06T 19/006; G06F 3/04815; G06T 2200/24

(57) ABSTRACT

Techniques for developing mixed reality applications in connection with a virtual development environment are disclosed. A reference model corresponding to a physical object is received. Then, the reference model is displayed in a virtual development environment. First input arranging an anchor with the reference model in the virtual development environment is received. Then, second input specifying an animation to apply to the reference model is received. The arrangement in the virtual development environment is used to construct a mixed reality application usable to display, in response to detecting an instance of the anchor in a physical environment, the animated reference model in accordance with the arrangement in the virtual development environment.

### CROSS-REFERENCE TO RELATED APPLICATIONS

This application claims the benefit of provisional U.S. Application No. 63/515,081, filed on Jul. 21, 2023, and entitled “DESKTOP BASED AR CONTENT CREATION AND PUBLISHING TOOL” which is hereby incorporated by reference in its entirety.

In cases where the present application conflicts with a document incorporated by reference, the present application controls.

### BACKGROUND

To create a mixed reality (MR) application, a developer typically establishes an anchor point within a physical modeled environment to which to connect the spatial reference frame of the MR application. Then, the developer manipulates virtual artifacts in the physical development environment relative to the anchor point to develop a mixed reality application.

### BRIEF DESCRIPTION OF THE DRAWINGS

FIG. 1 is a network diagram showing an environment in which the facility operates.

FIG. 2 is a block diagram showing some of the components typically incorporated in at least some of the computer systems and other devices on which the facility operates.

FIG. 3 is a flow diagram showing a process used by the facility in some embodiments to develop a mixed reality application in a virtual development environment.

FIG. 4 is a display diagram illustrating an interface used by the facility in some embodiments to receive reference data.

FIG. 5 is a display diagram illustrating an interface used by the facility in some embodiments to place a reference model in a virtual development environment.

FIG. 6 is a display diagram illustrating an interface used by the facility in some embodiments to select a type of anchor to place in the virtual development environment.

FIG. 7 is a display diagram illustrating an interface used by the facility in some embodiments to place an anchor in a virtual development environment.

FIG. 8 is a display diagram illustrating an interface used by the facility in some embodiments to create a mixed reality step in a procedure in a virtual development environment.

FIG. 9 is a display diagram illustrating an interface used by the facility in some embodiments to place a virtual artifact in a virtual development environment.

FIG. 10 is a display diagram illustrating an interface used by the facility in some embodiments to apply an animation to a virtual artifact in a virtual development environment.

FIG. 11 is a flow diagram showing a process used by the facility in some embodiments to develop a mixed reality application in a virtual development environment.

### DETAILED DESCRIPTION

The inventors have recognized that it would be useful for developers to be able to develop mixed reality applications in a virtual development environment not requiring (1) the use of gestural inputs native to a mixed reality interface or (2) presence in a physical development environment. For example, it would be helpful to receive a reference model of a feature in a physical environment for a mixed reality application usable to develop the mixed reality application away from the physical environment using a fully virtual interface.

The inventors have further recognized that conventional workflows for creating mixed reality applications require a developer to access a physical modeled environment. In particular, the inventors have recognized that development of mixed reality applications is hindered by the reliance of conventional techniques on prolonged access to a physical modeled environment and the use of gestural inputs native to a mixed reality interface while developing mixed reality applications. Conventional techniques are especially detrimental in cases where access to a physical modeled environment is limited, such as when a physical modeled environment includes active military equipment, industrial equipment, medical equipment, etc., that cannot be decommissioned to accommodate lengthy in-person mixed reality development workflows.

In response to recognizing these disadvantages, the inventors have conceived and reduced to practice a software and/or hardware facility for developing mixed reality applications in connection with a virtual development environment (“the facility”).

The facility supports developing a mixed reality application in a virtual development environment by receiving a reference model corresponding to a physical reference object. Then, the reference model is displayed in a virtual development environment. First input arranging an anchor with the reference model in the virtual development environment is received. Then, second input specifying an animation to apply to the reference model is received. The arrangement in the virtual development environment is used to construct a mixed reality application usable to display, in response to detecting an instance of the anchor in a physical environment, the animated reference model in accordance with the arrangement in the virtual development environment.

By performing in some or all of the ways described above, the facility improves development of mixed reality applications by enabling remote development. Also, the facility improves the functioning of computer or other hardware, such as by reducing the dynamic display area, processing, storage, and/or data transmission resources needed to perform a certain task, thereby enabling the task to be permitted by less capable, capacious, and/or expensive hardware devices, and/or be performed with lesser latency, and/or preserving more of the conserved resources for use in performing other tasks. For example, by enabling development of mixed reality applications in a virtual development environment, the facility conserves the additional storage and processing resources that would be required to continuously support an on-location physical development environment for a developer. Furthermore, the facility conserves resources required to correct erroneous gestural inputs commonly made in conventional physical development environment workflows. This permits less expensive devices having less storage or processing capacity to be used, or allows the same device to devote greater storage or processing capacity to other tasks.

Further, for at least some of the domains and scenarios discussed herein, the processes described herein as being performed automatically by a computing system cannot practically be performed in the human mind, for reasons that include that the starting data, intermediate state(s), and ending data are too voluminous and/or poorly organized for human access and processing, and/or are a form not perceivable and/or expressible by the human mind; the involved data manipulation operations and/or subprocesses are too complex, and/or too different from typical human mental operations; required response times are too short to be satisfied by human performance; etc.

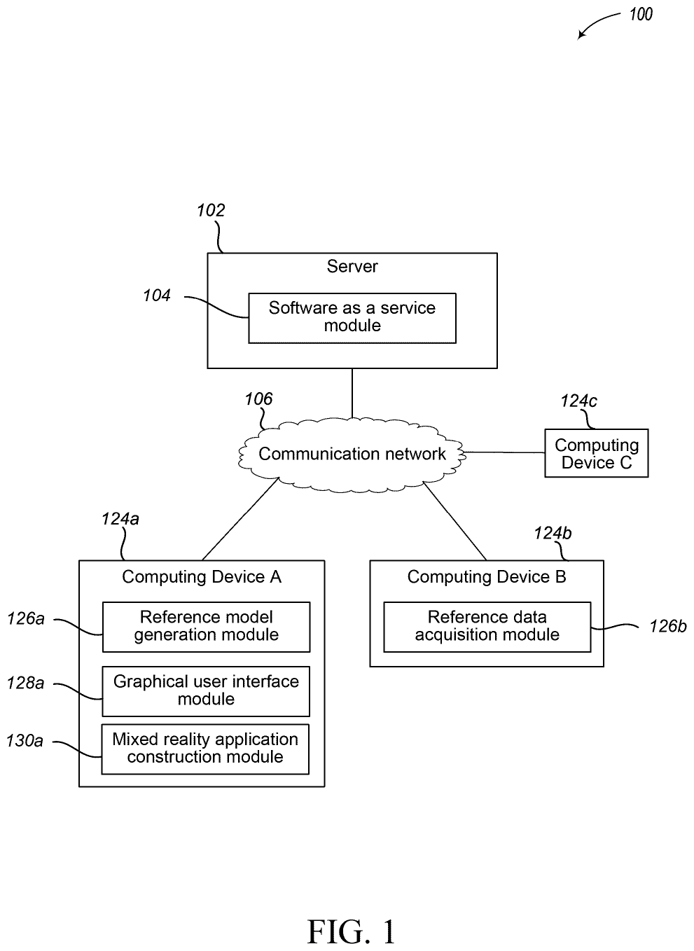

FIG. 1 is a network diagram showing an environment 100 in which the facility operates. In the example shown in FIG. 1, environment 100 includes a server 102 and one or more computing devices 124a-124c (collectively computing devices 124). Examples of computing device 124c include, but are not limited to, mobile devices, smartphones, tablets, laptop computers, or other computing devices that can capture images and present a mixed reality experience to a viewer. Examples of computing devices 124a and 124b further include servers, desktop computers, virtual machines, etc.

The facility is configured to receive reference data from a first computing device such as computing device 124b and use the reference data to generate a mixed reality application in response to inputs received by a second computing device such as computing device 124a that has a reference model generation module, a graphical user interface module, a mixed reality application module, and can be remote from the first computing device and a subject environment. Then, the mixed reality application is executed using a mixed reality device such as computing device 124c. In this way, the facility enables remote development of a mixed reality application using a fully virtual interface. In an example embodiment, computing device 124b is configured to obtain reference data including a three-dimensional scan of a workspace such as a workbench. The reference data is then sent through communication network 106 to computing device 124a, which enables a developer to create a mixed reality application based on the reference data. This enables the developer to create the mixed reality application for the workspace without using mixed reality interfaces or being present at the workspace.

Server 102 is configured as a computing system, e.g., cloud computing resource, that implements and executes software as a service module 104. In various embodiments, a separate instance of the software as a service module 104 is maintained and executed for each of the one or more computing devices 124.

In some embodiments, the facility provides one or more of modules 126a, 128a, 130a, or 126b (the modules) as a software as a service (SaaS).

Accordingly, server 102 in various embodiments controls deployment of the modules to computing devices 124 depending upon a subscription. In an example embodiment, software as a service module 104 provides computing device 124b access to reference data acquisition module 126b and causes data acquisition module to be operable with one or more of modules 126a, 128a, or 130a. In some embodiments, the facility routes communications between computing devices 124 through server 102 such that software as a service module 104 enables or disables module functionality according to a subscription. In some embodiments, one or more of computing devices 124 or server 102 are controlled by the same entity.

Software as a service module 104 supports various interfaces for computing devices 124 depending upon a permission of the computing device. In the example shown in FIG. 1, computing device 124b includes reference data acquisition module 126b. In various embodiments, reference data acquisition module 126b receives data from a camera, lidar scanner, etc., including data based on a physical reference object. Then, computing device 124b provides the data to computing device 124a, which provides various interfaces for remotely developing a mixed reality application. The mixed reality application is then executed using computing device 124c, which is in various embodiments a computing device 124a including reference model generation module 126a, graphical user interface module 128a, and mixed reality application construction module 130a.

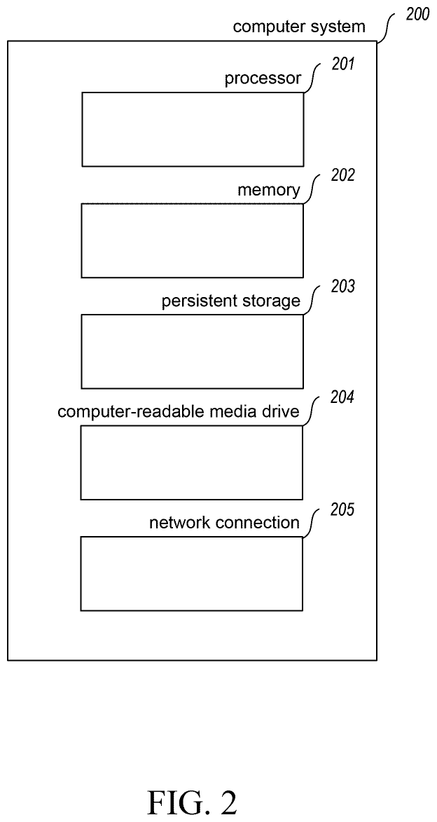

FIG. 2 is a block diagram showing some of the components typically incorporated in at least some of the computer systems and other devices on which the facility operates, such as server 102 or computing devices 124. In various embodiments, these computer systems and other devices 200 can include server computer systems, cloud computing platforms or virtual machines in other configurations, desktop computer systems, laptop computer systems, netbooks, mobile phones, personal digital assistants, televisions, cameras, automobile computers, electronic media players, etc. In various embodiments, the computer systems and devices include zero or more of each of the following: a processor 201 for executing computer programs and/or training or applying machine learning models, such as a CPU, GPU, TPU, NNP, FPGA, or ASIC; a computer memory 202—such as RAM, SDRAM, ROM, PROM, etc.—for storing programs and data while they are being used, including the facility and associated data, an operating system including a kernel, and device drivers; a persistent storage device 203, such as a hard drive or flash drive for persistently storing programs and data; a computer-readable media drive 204, such as a floppy, CD-ROM, or DVD drive, for reading programs and data stored on a computer-readable medium; and a network connection 205 for connecting the computer system to other computer systems to send and/or receive data, such as via the Internet or another network and its networking hardware, such as switches, routers, repeaters, electrical cables and optical fibers, light emitters and receivers, radio transmitters and receivers, and the like. None of the components shown in FIG. 2 and discussed above constitutes a data signal per se. While computer systems configured as described above are typically used to support the operation of the facility, those skilled in the art will appreciate that the facility may be implemented using devices of various types and configurations, and having various components.

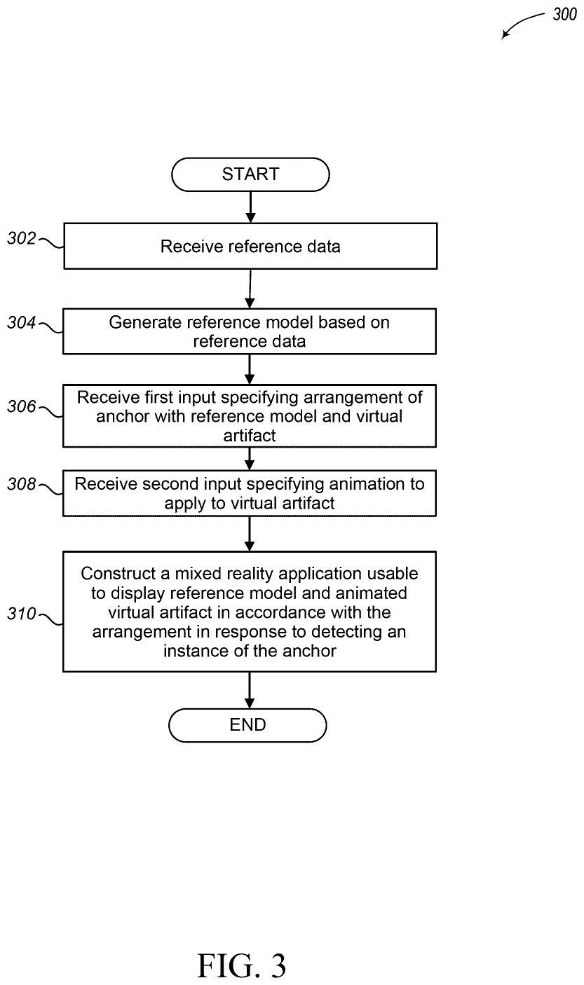

FIG. 3 is a flow diagram showing a process 300 used by the facility in some embodiments to develop a mixed reality application in a virtual development environment. Process 300 begins, after a start block, at block 302 where the facility receives reference data. In some embodiments, the reference data includes a file that specifies a 3D model for an object. The file is in various embodiments a Filmbox, OBJ, GL Transmission Format Binary file (GLB), or Graphics Library Transmission Format (gITF) file. In an example embodiment, the reference data includes a 3D model of an environment containing a plurality of 3D-modeled objects.

In some embodiments, the reference data includes a 3D model that is based on a scan of a physical object. For example, the reference data in various embodiments includes a 3D model of a table obtained by scanning the table, or a 3D model of a physical environment obtained by scanning the physical environment. The scanning is performed in various embodiments by laser scanning such as LiDAR, photogrammetry, contact scanning such as by a coordinate measuring machine, etc.

In some embodiments, the reference data includes a 3D model created using a computer aided design software such as Blender®, SolidWorks®, AutoCAD®, etc.

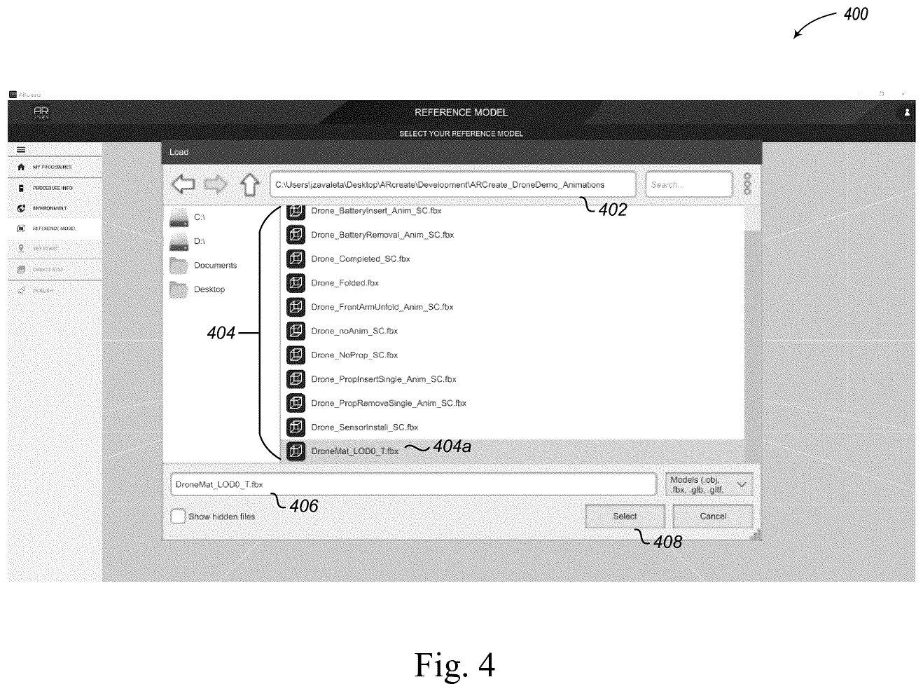

FIG. 4 is a display diagram illustrating an interface 400 used by the facility in some embodiments to receive reference data. In the example shown in FIG. 4, a user navigates to directory path 402 to view reference model files 404. The user then selects a reference model file among reference model files 404, such as reference model file 404a. The name of the reference model file 404a is displayed in selection field 406. The user then confirms the selection with select button 408. While FIG. 4 and each of the display diagrams discussed below show a display whose formatting, organization, informational density, etc., is best suited to certain types of display devices, those skilled in the art will appreciate that actual displays presented by the facility may differ from those shown, in that they may be optimized for particular other display devices, or have shown visual elements omitted, visual elements not shown included, visual elements reorganized, reformatted, revisualized, or shown at different levels of magnification, etc.

Returning to FIG. 3, after receiving reference data at block 302, process 300 proceeds to block 304. At block 304, the facility generates a reference model based on the reference data.

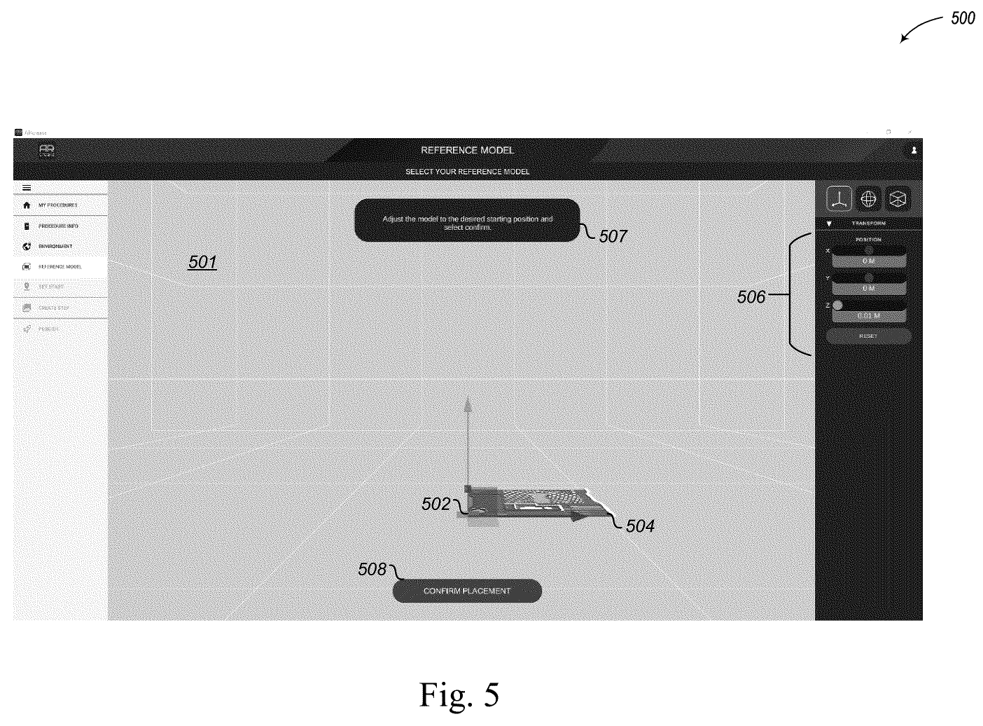

FIG. 5 is a display diagram illustrating an interface 500 used by the facility in some embodiments to place a reference model in a virtual development environment. In the example shown in FIG. 5, a user is instructed by instructions 507 to place and adjust reference model 504 relative to origin 502 in virtual environment 501 using transform controls 506. In this example, transform controls 506 reflects reference model 504's position in virtual environment 501 relative to origin 502. The user in some embodiments adjusts the position of reference model 504 using transform controls 506 by inputting values for one or more coordinates. In some embodiments, the user adjusts the position of reference model 504 using a cursor and transform controls 506 reflect the adjusted position. The user then confirms placement of reference model 504 using confirm placement button 508. The facility in some embodiments provides the virtual development in the form of a software as a service.

Returning to FIG. 3, after generating a reference model based on the reference data at block 304, process 300 proceeds to block 306, where the facility receives first input specifying an arrangement of an anchor with the reference model and a virtual artifact in a virtual development environment.

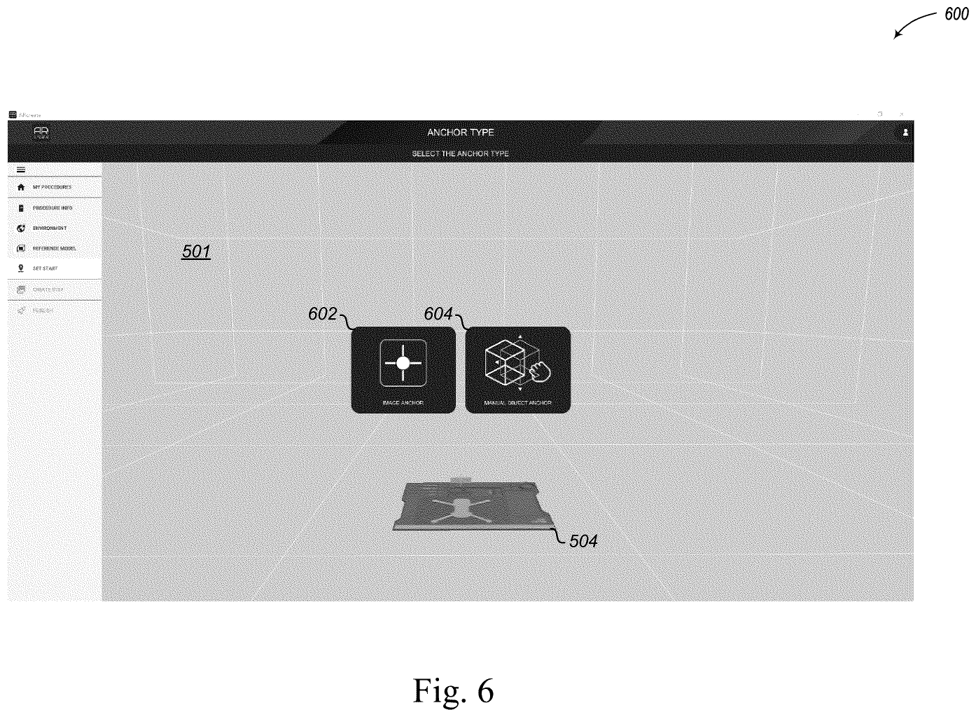

FIG. 6 is a display diagram illustrating an interface 600 used by the facility in some embodiments to select a type of anchor to place in the virtual development environment. An anchor is an expected feature in an environment that is detected and tracked by a mixed reality device to ensure that virtual artifacts in a mixed reality experience appear to a viewer of the mixed reality experience to stay at the same position and orientation in space. In various embodiments, the anchor is an image anchor, an object anchor, a geo anchor, a location anchor, an auto anchor, etc. An image anchor includes a single predefined image or Quick Response (QR) code to be detected. An object anchor includes a reference model to be detected. A geo anchor includes a GPS location to be detected, while a location anchor includes one or more features in a physical environment to be detected.

In some embodiments, the anchor is coupled to the reference model such that a transformation applied to the reference model in the virtual development environment causes the anchor to be arranged such that the anchor maintains its position relative to the reference model. For example, an anchor placed on a reference model of a table in an example embodiment remains in the same position on the table when the table is rotated, translated, etc.

In the example shown in FIG. 6, a user selects image anchor button 602 or manual object anchor button 604 to add an image anchor or a manual object anchor, respectively, to place in virtual environment 501 with respect to reference model 504. In this example, the user selects image anchor button 602. In various embodiments, interface 600 displays buttons corresponding to any set of the anchors discussed herein. For example, interface 600 in an example embodiment displays a button corresponding to a geo anchor and a button corresponding to a location anchor. In some embodiments, the facility automatically selects a type of anchor to be used. In some embodiments, the facility does not display interface 600.

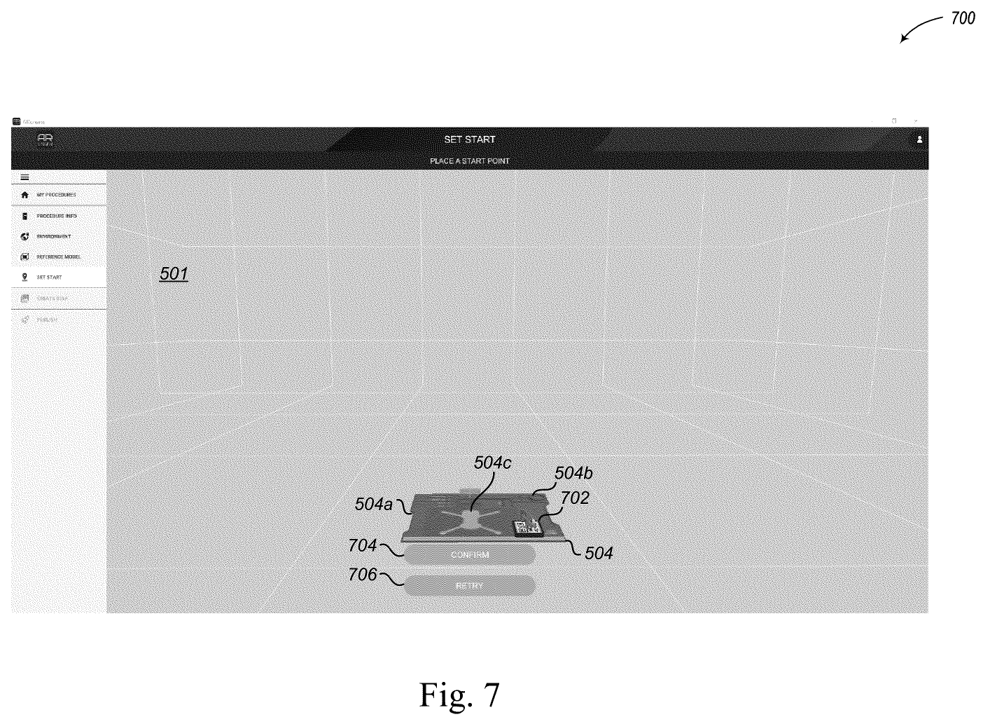

FIG. 7 is a display diagram illustrating an interface 700 used by the facility in some embodiments to place an anchor in a virtual development environment. In the example shown in FIG. 7, the user is placing anchor 702 in virtual environment 501 with respect to reference model 504. Anchor 702 includes a QR code to be detected by a mixed reality device. In some embodiments, the facility receives arrangement of anchor 702 by a cursor or other user input. In some embodiments, the facility automatically arranges anchor 702 based on a position of reference model 504, a dimension of reference model 504, or a combination thereof. The facility receives confirmation of the arrangement by confirm button 704. The facility allows the user to retry arranging anchor 702 by retry button 706. In some embodiments, the facility automatically arranges anchor 702 in response to receiving selection of retry button 706.

While the example in FIG. 7 shows placement of an image anchor, interface 700 is in various embodiments used to place any anchor type in the virtual development environment. For example, the facility may receive placement of a geo location anchor corresponding to one or more specified latitudes and longitudes with respect to reference model 504. In some embodiments, the facility automatically places the anchor in the virtual development environment. In some embodiments, the facility automatically generates an anchor based on reference model 504. For example, in some embodiments the facility automatically generates an object anchor based on reference model 504. The object anchor includes a plurality of selected points defined by reference model 504 and corresponding to a physical object to be detected in a mixed reality experience. In some embodiments, the plurality of points defined by reference model 504 are selected based on a level of information provided by the plurality of points such as a density of points per unit area in reference model 504. For example, if reference model 504 is a cube, it is fully defined in space by one point at each corner of the cube and the density of points per unit area is likely to be low. Certain distinctive features of reference model 504, however, require a larger number of points to be fully defined in space, such as notch 504a, feature 504b, etc., indicating a higher level of information. One or more points included in the distinctive features may be used to create an object anchor corresponding to reference model 504. By creating an object anchor including distinctive points, the facility reduces false positive detections of an object corresponding to the object anchor.

In some embodiments, the facility automatically generates an image anchor based on reference model 504. For example, reference model 504 may contain image data including colors or two-dimensional features such as drone outline 504c. Distinctive elements of the image data may be used to generate the image anchor. For example, the facility in some embodiments automatically generates the image anchor using points in the image data corresponding to color changes, specific colors in the image data, etc.

In some embodiments, the facility causes the virtual development environment to be displayed such that the display emulates a view of the contents of the virtual development environment through a mixed reality device.

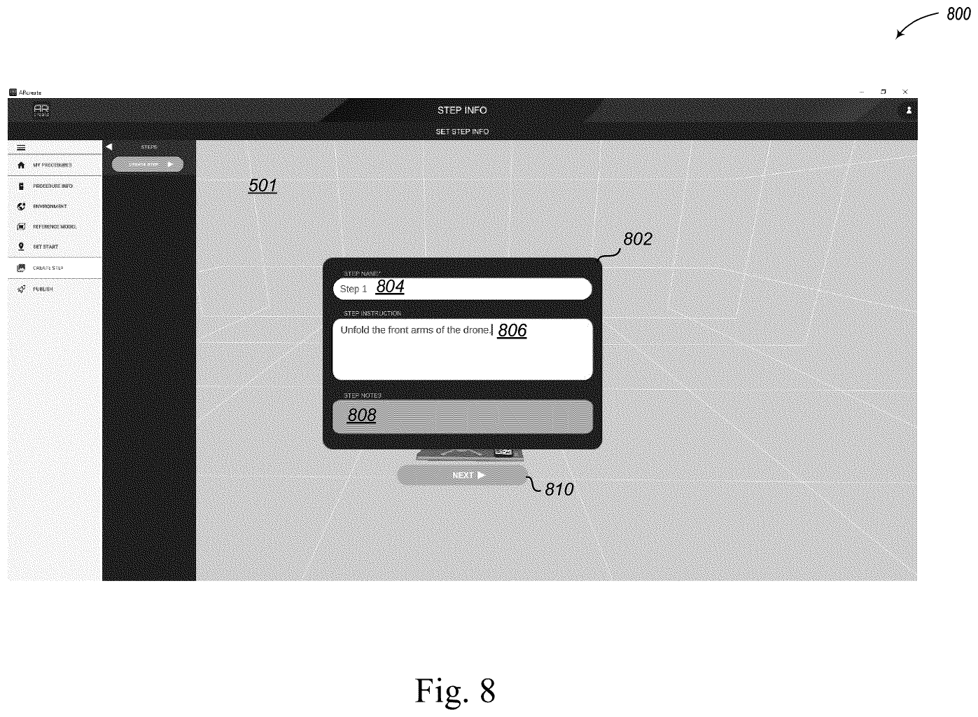

FIG. 8 is a display diagram illustrating an interface 800 used by the facility in some embodiments to create a mixed reality step in a procedure in a virtual development environment. In various embodiments, a mixed reality experience is divided into mixed reality steps comprising a procedure. In some embodiments, the mixed reality steps correspond to actions to be taken by a viewer of the mixed reality experience. For example, in a mixed reality experience designed to instruct a viewer how to assemble a drone, a first mixed reality step may include unfolding the front arms of the drone and a second mixed reality step may include unfolding the rear arms of the drone. In some embodiments, animations corresponding to the mixed reality steps are sequentially displayed to guide a viewer through a procedure. The facility in some embodiments causes one or more animations to be displayed in one or more of the mixed reality steps. For example, in the first mixed reality step, the facility may display an animation of the front arms of a drone being unfolded. In some embodiments, the one or more animations depict a condition present in the procedure. For example, an animation spinning a propeller of the drone may be included to indicate a hazard presented by spinning propellers at one or more mixed reality steps in the procedure.

In the example shown in FIG. 8, the facility displays input window 802 including input fields MR step name 804, MR step instruction 806, and MR step notes 808. The facility in some embodiments receives input for one or more of the input fields before allowing selection of next button 810 to be selected. In some embodiments, the facility allows next button 810 to be selected despite one or more of the input fields being empty.

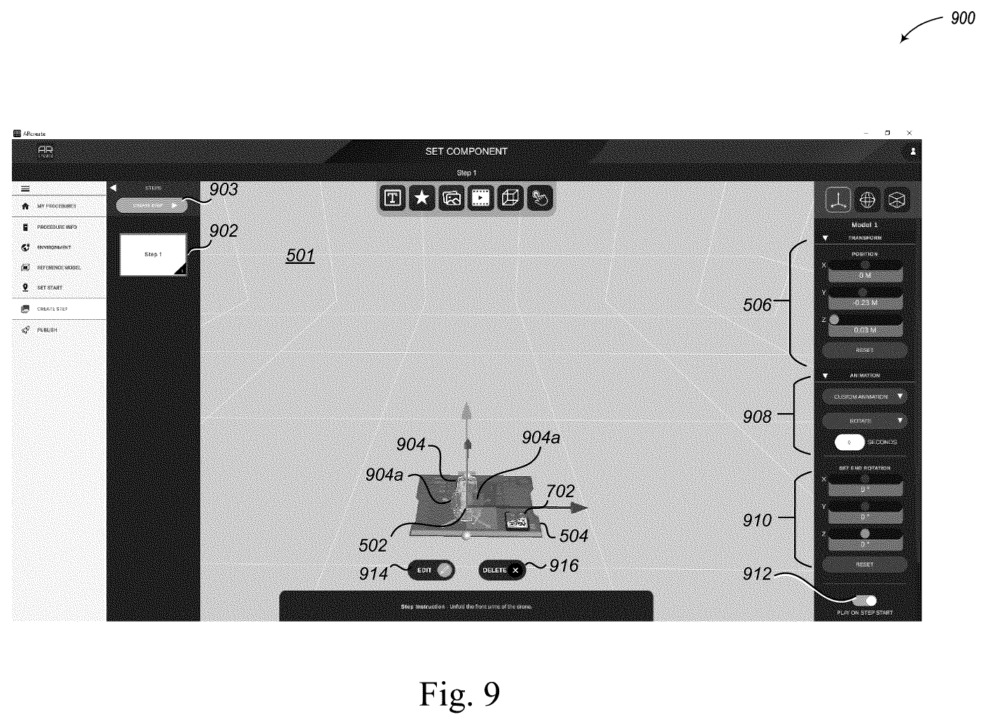

FIG. 9 is a display diagram illustrating an interface 900 used by the facility in some embodiments to place a virtual artifact in a virtual development environment. Step indicator 902 indicates an MR step in a procedure for which a virtual artifact is being placed. In the example shown in FIG. 9, the procedure comprises one MR step indicator 902 corresponding to the information received by interface 800 in FIG. 8. In various embodiments, the facility displays a plurality of MR steps (not shown) and allows the user to navigate to an interface to place a virtual artifact with respect to the selected MR step. Create MR step button 903 allows the user to add a new MR step to the procedure. In some embodiments, the facility displays interface 800 in FIG. 8 in response to receiving selection of create MR step button 903.

In the example shown in FIG. 9, virtual artifact 904 including virtual artifact component 904a is displayed in virtual environment 501. The facility in some embodiments receives input to change a position of virtual artifact 904 from transform controls 506. The facility uses animation controls 908 to receive selection of various animations to apply to one or more of virtual artifact 904, virtual artifact component 904a, or reference model 504. In the example shown in FIG. 9, animation controls 908 specify that a custom rotation animation having a duration of zero seconds is to be applied to virtual artifact component 904a. The facility uses rotation controls 910 to receive input specifying rotation parameters. Play on MR step start selector 912 allows the facility to receive input specifying when to display the animation. Edit button 914 supports the facility receiving selection of an object to arrange using interface 900. Delete button 916 supports the facility receiving input specifying to delete a selected object.

In some embodiments, the virtual artifact includes text associated with an MR step such as MR step instruction 806 in FIG. 8. In an example embodiment, the text “Unfold the front arms of the drone” included in MR step instruction 806 is the virtual artifact.

Returning to FIG. 3, after receiving first input specifying an arrangement of an anchor with the reference model and a virtual artifact in block 306, process 300 proceeds to block 308. In some embodiments, the arrangement includes the facility receiving one or more coordinates in the virtual development environment at which to position the anchor in the virtual development environment. At block 308, the facility receives second input specifying an animation to apply to the virtual artifact. After block 308, process 300 proceeds to block 310.

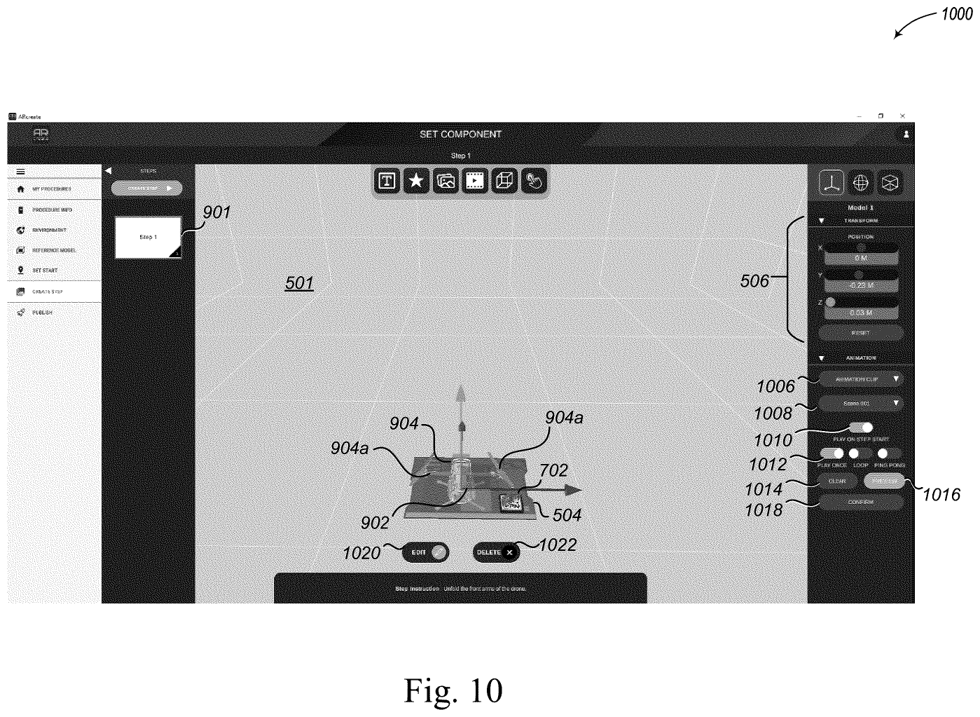

FIG. 10 is a display diagram illustrating an interface 1000 used by the facility in some embodiments to apply an animation to a virtual artifact in a virtual development environment. Animation type selector 1006 supports the facility receiving selection of a type of animation to apply to a selected object. Here, an animation clip is selected. Clip selector 1008 supports the facility receiving input specifying an animation clip to apply to the selected object, while play on MR step start button 1010 supports playing the animation at the start of the MR step.

Animation behavior selectors 1012 support the facility receiving a selection of a behavior of the animation. Here, the selection indicates that the animation is to be played once. In various embodiments, the animation is played repeatedly in response to selection of the loop or ping pong setting. Clear button 1014 supports clearing the current animation settings. In some embodiments, the facility clears all animation settings in response to a selection of clear button 1014. In some embodiments, the facility clears a subset of the current animation settings. Preview button 1016 causes the facility to display a preview of the animation settings as applied to the selected component. In the example shown in FIG. 10, the facility causes the selected animation clip to be applied to virtual artifact component 904a, rotating the drone arms 90 degrees and unfolding the propeller blades as compared to the folded drone arms and propellers displayed in FIG. 9. In response to selection of confirm button 1018, the facility in various embodiments hides the animation settings, enables selection of another model to animate, or exits interface 1000. In response to receiving selection of edit button 1020, the facility makes animation controls available for a selected model. In some embodiments, the animation controls are reset to default values in response to selection of the model and the edit button. Receiving selection of delete button 1022 causes the facility to delete a selected animation.

Returning to FIG. 3, process 300 continues to block 310, where the facility constructs a mixed reality application usable to display the reference model and animated virtual artifact in accordance with the arrangement in response to detecting an instance of the anchor. In some embodiments, the facility uses the mixed reality application to cause a mixed reality experience to be presented to a viewer. In some embodiments, the mixed reality application is constructed for use with a type of mixed reality device not used in performing the arrangement of the anchor with the reference model and the virtual artifact. In an example embodiment, the arrangement is performed using a desktop computer. Accordingly, the mixed reality application is compiled to be used with a type of mixed reality device not used in performing the arrangement such as a mixed reality headset or a cell phone. After block 310, process 300 ends at an end block.

Those skilled in the art will appreciate that the acts shown in FIG. 3 and in each of the flow diagrams discussed below may be altered in a variety of ways. For example, the order of the acts may be rearranged; some acts may be performed in parallel; shown acts may be omitted, or other acts may be included; a shown act may be divided into subacts, or multiple shown acts may be combined into a single act, etc.

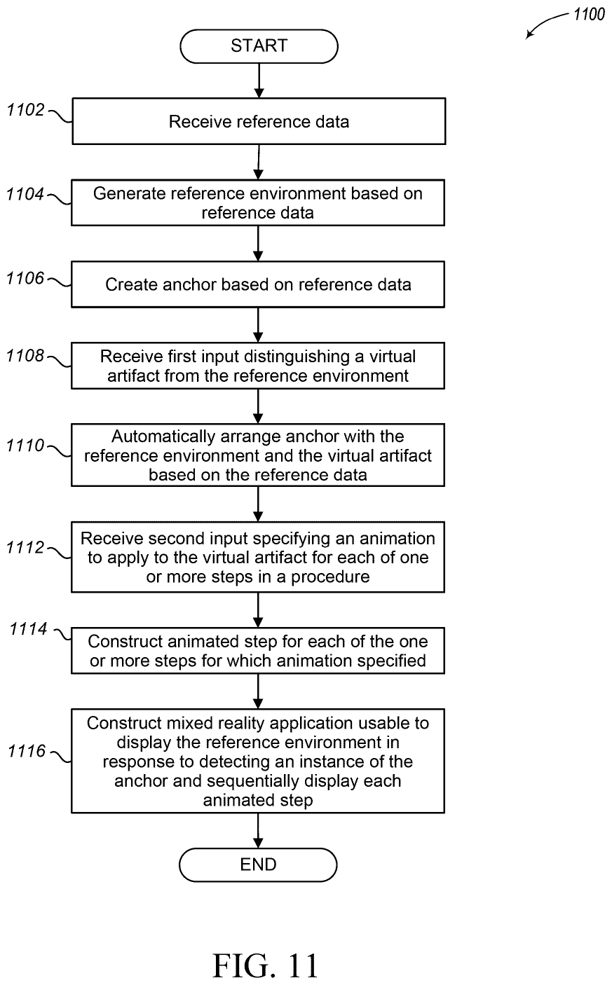

FIG. 11 is a flow diagram showing a process used by the facility in some embodiments to develop a mixed reality application in a virtual development environment.

Process 1100 begins, after a start block, at block 1102 where the facility receives reference data. In various embodiments, block 1102 employs embodiments of block 302 in FIG. 3 to receive the reference data. In some embodiments, the reference data includes information about a physical environment including a virtual artifact to be animated. For example, if a drone component is the virtual artifact, the reference data may include environmental features such as a table the drone is to be manipulated on, aspects of a room in which the drone is to be manipulated, etc. In another example where the reference model is a control panel of an aircraft, the reference data includes information about the cockpit of an aircraft including other controls or features. In some embodiments, the reference data includes a plurality of virtual artifacts. In various embodiments, the reference data includes a sequence of scans of a physical environment during a period of time such that the reference data is usable to reconstruct an animated reference environment. In various embodiments, a computing device is configured to remain in the physical environment and provide real-time reference data on demand or collect reference data including selected events. After block 1102, process 1100 continues to block 1104.

At block 1104, the facility generates a reference environment based on reference data. In various embodiments, block 1104 employs embodiments of block 304 in FIG. 3 to generate a reference environment based on the reference data. In some embodiments, the reference environment includes a plurality of distinct physical objects comprising a physical environment including the virtual artifact. After block 1104, process 1100 continues to block 1106.

At block 1106, the facility creates an anchor based on the reference data. In various embodiments, block 1106 employs embodiments of block 306 in FIG. 3 to create the anchor based on the reference data. After block 1106, process 1100 continues to block 1108.

At block 1108, the facility receives first input distinguishing a virtual artifact from the reference environment. In an example embodiment, the reference data includes the virtual artifact and various data corresponding to physical features around the virtual artifact. Referring to FIG. 9, for example, the reference data may include virtual artifact 904 and reference model 504 as a single undifferentiated model created by scanning a drone on a table. To apply an animation to the virtual artifact alone, the virtual artifact is segmented from the reference environment. In some embodiments, the facility supports distinguishing the virtual artifact by receiving a selection of a volume of the reference environment consisting of the virtual artifact. For example, the facility in an example embodiment provides a configurable three-dimensional selection box that is adjusted to contain the drone but not the table. In various embodiments, the volume to distinguish the virtual artifact is specified using any suitable three-dimensional mesh.

In some embodiments, the facility uses image processing techniques such as edge detection. After block 1108, process 1100 continues to block 1110. In various embodiments, the facility provides for hierarchical segmentation of one or more objects in the reference environment. Referring again to FIG. 9, a user may desire to apply an animation to virtual artifact component 904a. Using the techniques described above, the user may segment virtual artifact 904 from the reference environment, and further segment virtual artifact component 904a from virtual artifact 904, thus enabling an animation to be applied to virtual artifact component 904a as shown in FIG. 9 and FIG. 10. This supports animation of a component in an assembly including the reference model.

At block 1110, the facility automatically arranges the anchor with the reference environment and the virtual artifact based on the reference data. In various embodiments, block 1110 employs embodiments described with respect to FIG. 7 to automatically arrange the anchor with the reference environment and the virtual artifact based on the reference data. In some embodiments, the facility displays the reference environment such that it emulates a view of the corresponding physical modeled environment on which the reference environment is based as viewed through a mixed reality device. After block 1110, process 1100 continues to block 1112.

At block 1112, the facility receives a second input specifying an animation to apply to the virtual artifact for each of one or more MR steps in a procedure. In various embodiments, block 1112 employs embodiments of block 308 in FIG. 3 to receive second input specifying an animation to apply to the virtual artifact for each of one or more MR steps in the procedure. While the above discussion has considered applying one or more animations to a virtual artifact, the disclosure is not so limited. In some embodiments, the animation in one or more MR steps is applied to a component of the virtual artifact. In some embodiments, an animation is applied to a plurality of models. For example, a plurality of animations may be applied to a drone propeller, a status light on the drone, and a reference environment object such as a fan all during a same MR step. Similarly, a set of objects to which animations are applied in some embodiments varies in one or more MR steps. For example, in a first MR step a drone propeller and status light are animated while in a second MR step only the drone light is animated. After block 1112, process 1100 continues to block 1114.

At block 1114, the facility constructs an animated MR step for each of the one or more MR steps for which an animation is specified. In some embodiments, the animated MR step is created by associating an animation with an MR step using interface 900 in FIG. 9 or interface 1000 in FIG. 10. After block 1114, process 1100 continues to block 1116.

At block 1116, the facility constructs a mixed reality application usable to display the virtual modeled environment in response to detecting an instance of the anchor, and to sequentially display each animated MR step. After block 1116, process 1100 ends at an end block.

The following is a summarization of the claims as originally filed.

A method in a first computing device for developing a mixed reality application in a virtual development environment may be summarized as: receiving reference data corresponding to a physical reference object and captured by a second computing device distinct from the first computing device; generating, based on the reference data, a reference model for the virtual development environment; receiving, via a graphical user interface, first input specifying an arrangement of an anchor with the reference model and a virtual artifact in the virtual development environment; receiving, via a graphical user interface, second input specifying an animation to apply to the virtual artifact; and using the arrangement in the virtual development environment to construct the mixed reality application usable to display, in response to detecting an instance of the anchor in a physical environment, the reference model and the animated virtual artifact in accordance with the arrangement in the virtual development environment.

In some embodiments, the anchor is coupled to the reference model such that a transformation applied to the reference model in the virtual development environment causes the anchor to be arranged such that the anchor maintains its position relative to the reference model.

In some embodiments, the method includes causing a mixed reality experience based on the mixed reality application to be presented to a viewer.

In some embodiments, the method includes providing the virtual development environment in the form of a software as a service.

In some embodiments, the anchor is based on the reference model and the instance of the anchor in the physical environment may be the physical reference object.

In some embodiments, the anchor is based on the reference model.

In some embodiments, the reference data is based on a scan of the physical reference object.

In some embodiments, the method includes receiving a reference environment corresponding to a physical environment and displaying the reference environment in the virtual development environment.

In some embodiments, the virtual development environment emulates a view through a mixed reality device of a physical modeled environment.

In some embodiments, the arranging includes specifying one or more coordinates in the virtual development environment at which to position the anchor in the virtual development environment.

In some embodiments, the mixed reality application is constructed for use with a type of mixed reality device not used in performing the arrangement.

In some embodiments, the virtual artifact includes text corresponding to an action to be taken by a viewer of a mixed reality experience displayed using the mixed reality application.

In some embodiments, the virtual artifact is a component in an assembly including the reference model.

In some embodiments, the animation demonstrates an action to be taken by a viewer of a mixed reality experience displayed using the mixed reality application.

In some embodiments, soliciting the animation to apply to the virtual artifact comprises presenting, by the graphical user interface, one or more indications of animations; receiving a selection of an indication in the one or more indications; and applying the animation corresponding to the indication to the virtual artifact.

A system for developing a mixed reality application in a virtual development environment may be summarized as including: one or more memories configured to collectively store computer instructions; and one or more processors configured to collectively execute the stored computer instructions to perform a method, the method comprising: receiving reference data corresponding to a physical modeled environment; receiving a procedure including a plurality of MR steps; generating, based on the reference data, a reference environment for the virtual development environment; displaying the reference environment in the virtual development environment; receiving first input distinguishing from the reference environment a virtual artifact corresponding to a physical reference object; automatically arranging, based on the reference data, an anchor with the reference environment and the virtual artifact in the virtual development environment; receiving second input specifying, for one or more MR steps in a procedure, a corresponding animation to apply to the virtual artifact; constructing, for each of the one or more MR steps in the procedure, an animated MR step based on the corresponding animation; and constructing, using the one or more animated MR steps, a mixed reality application usable to: display, in response to detecting an instance of the anchor in a physical environment, the virtual artifact in accordance with the arrangement; and sequentially display each animated MR step in the one or more animated MR steps.

In some embodiments, the mixed reality application is usable to sequentially display the animated MR steps in accordance with actions taken by a viewer of a mixed reality experience based on the mixed reality application.

In some embodiments, the procedure reflects one or more actions to be taken by a viewer of a mixed reality experience displayed using the mixed reality application.

In some embodiments, an animated MR step in the one or more animated MR steps demonstrates an action to be taken by a viewer of a mixed reality experience displayed using the mixed reality application.

One or more memories collectively storing instructions that, when executed by one or more processors in a computing system, cause the one or more processors to perform a method, the method may be summarized as including: receiving a reference model corresponding to a physical object; displaying the reference model in a virtual development environment; receiving first input arranging an anchor with the reference model in the virtual development environment; receiving second input specifying an animation to apply to the reference model; and using the arrangement in the virtual development environment to construct a mixed reality application usable to display, in response to detecting an instance of the anchor in a physical environment, the animated reference model in accordance with the arrangement in the virtual development environment.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A system for developing a mixed reality application in a virtual development environment, the system comprising:
one or more memories configured to collectively store computer instructions; and
one or more processors configured to collectively execute the stored computer instructions to perform a method, the method comprising:
receiving reference data corresponding to a physical modeled environment;
receiving a procedure including a plurality of mixed reality steps;
generating, based on the reference data, a reference environment for the virtual development environment;
displaying the reference environment in the virtual development environment;
receiving first input distinguishing from the reference environment a virtual artifact corresponding to a physical reference object;
automatically arranging, based on the reference data, an anchor with the reference environment and the virtual artifact in the virtual development environment;
receiving second input specifying, for one or more mixed reality steps in a procedure, a corresponding animation to apply to the virtual artifact;
constructing, for each of the one or more mixed reality steps in the procedure, an animated mixed reality step based on the corresponding animation; and
constructing, using the one or more animated mixed reality steps, a mixed reality application usable to:
display, in response to detecting an instance of the anchor in a physical environment, the virtual artifact in accordance with the arrangement; and
sequentially display each animated mixed reality step in the one or more animated mixed reality steps.

2. The system of claim 1, wherein the mixed reality application is usable to sequentially display the animated mixed reality steps in accordance with actions taken by a viewer of a mixed reality experience based on the mixed reality application.

3. The system of claim 1, wherein the procedure reflects one or more actions to be taken by a viewer of a mixed reality experience displayed using the mixed reality application.

4. The system of claim 1, wherein an animated mixed reality step in the one or more animated mixed reality steps demonstrates an action to be taken by a viewer of a mixed reality experience displayed using the mixed reality application.

5. A method in a first computing device for developing a mixed reality application in a virtual development environment, the method comprising:
receiving reference data corresponding to a physical reference object and captured by a second computing device distinct from the first computing device;
generating, based on the reference data, a reference model for the virtual development environment;
receiving, via a graphical user interface, first input specifying an arrangement of an anchor with the reference model and a virtual artifact in the virtual development environment;
receiving, via a graphical user interface, second input specifying an animation to apply to the virtual artifact; and
using the arrangement in the virtual development environment to construct the mixed reality application usable to display, in response to detecting an instance of the anchor in a physical environment, the reference model and the animated virtual artifact in accordance with the arrangement in the virtual development environment.

6. The method of claim 5, wherein the anchor is coupled to the reference model such that a transformation applied to the reference model in the virtual development environment causes the anchor to be arranged such that the anchor maintains its position relative to the reference model.

7. The method of claim 5, further comprising causing a mixed reality experience based on the mixed reality application to be presented to a viewer.

8. The method of claim 5, wherein the virtual development environment is provided in the form of a software as a service.

9. The method of claim 5, wherein the anchor is based on the reference model and the instance of the anchor in the physical environment is the physical reference object.

10. The method of claim 5, wherein the anchor is based on the reference model.

11. The method of claim 5, wherein the reference data is based on a scan of the physical reference object.

12. The method of claim 5, further comprising:
receiving a reference environment corresponding to a physical environment and displaying the reference environment in the virtual development environment.

13. The method of claim 5, wherein the virtual development environment emulates a view through a mixed reality device of a physical modeled environment.

14. The method of claim 5, wherein the arranging comprises specifying one or more coordinates in the virtual development environment at which to position the anchor in the virtual development environment.

15. The method of claim 5, wherein the mixed reality application is constructed for use with a type of mixed reality device not used in performing the arrangement.

16. The method of claim 5, wherein the virtual artifact includes text corresponding to an action to be taken by a viewer of a mixed reality experience displayed using the mixed reality application.

17. The method of claim 5, wherein the virtual artifact is a component in an assembly including the reference model.

18. The method of claim 5, wherein the animation demonstrates an action to be taken by a viewer of a mixed reality experience displayed using the mixed reality application.

19. The method of claim 5, wherein soliciting the animation to apply to the virtual artifact comprises presenting, by the graphical user interface, one or more indications of animations; receiving a selection of an indication in the one or more indications; and applying the animation corresponding to the indication to the virtual artifact.

20. One or more memories collectively storing instructions that, when executed by one or more processors in a computing system, cause the one or more processors to perform a method, the method comprising:
receiving a reference model corresponding to a physical object;
displaying the reference model in a virtual development environment;
receiving first input arranging an anchor with the reference model in the virtual development environment;
receiving second input specifying an animation to apply to the reference model; and
using the arrangement in the virtual development environment to construct a mixed reality application usable to display, in response to detecting an instance of the anchor in a physical environment, the animated reference model in accordance with the arrangement in the virtual development environment.
